(19) United States
(12) Patent Application Publication
(10) Pub. No.: US 2013/0061316 A1
(43) Pub. Date: Mar. 7, 2013

(54) Capability Access Management for Processes

(71) Applicants: Sermet Iskin, Bellevue, WA (US); John A.M. Hazen, Kirkland, WA (US); Liang Zhao, Bothell, WA (US); Scott B. Graham, Seattle, WA (US); John M. Sheelan, Cambridge, MA (US)

(72) Inventors: Sermet Iskin, Bellevue, WA (US); John A.M. Hazen, Kirkland, WA (US); Liang Zhao, Bothell, WA (US); Scott B. Graham, Seattle, WA (US); John M. Sheelan, Cambridge, MA (US)

(73) Assignee: Microsoft Corporation, Redmond, WA (US)

(21) Appl. No.: 13/225,945

(22) Filed: Sep. 6, 2011

(51) Int. Cl. G06F 21/00

(52) U.S. Cl. 726/18

(57) ABSTRACT

Capability access management techniques for processes are described. In one or more implementations, a token is formed having one or more security identifiers that reference capabilities described in a manifest for the executable code responsive to an input received to initiate execution of executable code installed on the computing device. The one or more processes formed through execution of the executable code on the computing device are associated with the token, the token usable to manage access of the one or more processes to the capabilities of the computing device.

### BACKGROUND

The ways in which users may gain access to executable code (e.g., software) for execution by a computing device is ever increasing. For example, users traditionally ventured to a “bricks-and-mortar” store to locate and purchase applications that were then installed manually by the users. Consequently, the users could typically trust the software due to the reputation of the store itself as well as the reputation of the developers of the software.

However, with the advent of application marketplaces users may have access to thousands of different types of applications from hundreds and even thousands of different developers. Therefore, a user may install a multitude of applications on a computing device from a wide variety of sources, some of which may even result in one application compromising another application. Consequently, it may be difficult to determine by the user and even by the marketplace itself as to whether the applications are trustworthy and therefore should be permitted to access functionality of a user's computing device. This difficulty may be further exacerbated by malicious parties that may attack the applications to access functionality supported by the application, such as access to sensitive data, even for applications that originated from a trustworthy source.

### SUMMARY

Capability access management techniques for processes are described. In one or more implementations, a token is formed having one or more security identifiers that reference capabilities described in a manifest for the executable code responsive to an input received to initiate execution of executable code installed on the computing device. The one or more processes formed through execution of the executable code on the computing device are associated with the token, the token usable to manage access of the one or more processes to the capabilities of the computing device.

In one or more implementations, a package is received at a computing device that includes executable code and a manifest that describes capabilities of the executable code. The executable code is installed on the computing device and the capabilities described by the manifest for the executable code are stored in a capabilities store on the computing device. The saved capabilities are usable to form a token to manage access of one or more processes formed through execution of the executable code to capabilities of the computing device.

In one or more implementations, one or more computer-readable storage media comprise instructions stored thereon that, responsive to execution on a computing device, cause the computing device to execute an operating system. Execution of the operating system may be performed to receive a request from a process to access a capability of the computing device, examine a token that corresponds to the process to determine whether access to the capability is permitted for the process, the token having one or more security identifiers that reference capabilities described in a manifest that corresponds to the process, and manage the access to the capability based on the examination of the token.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform process capability techniques.

FIG. 2 is an illustration of a system in an example implementation showing example implementation of a process capability access management technique.

FIG. 3 is a flow diagram depicting a procedure in an example implementation in which a package having executable code and a manifest are installed on a computing device.

FIG. 4 is a flow diagram depicting a procedure in an example implementation in which a token is formed responsive to initiating execution of the executable code installed in FIG. 4.

FIG. 5 is a flow diagram depicting a procedure in an example implementation in which access to capabilities is managed by a computing device using the token formed in FIG. 4.

FIG. 6 illustrates an example system that includes the computing device as described with reference to FIG. 1.

FIG. 7 illustrates various components of an example device that can be implemented as any type of computing device as described with reference to FIGS. 1, 2, and 6 to implement embodiments of the techniques described herein.

### DETAILED DESCRIPTION

### Overview

Traditionally, applications that were executed on a computing device were given access to most if not all of the functionality of the computing device, even regardless of whether this access was desired. This may include unfettered access to a wide variety of personal user data and resources, such as devices, user credentials, and so on. However, in some instances these same applications may be exploited by malicious parties, which may range from web-connected functionality that can be manipulated by an attacker to malformed files that contain a malicious payload. Consequently, the broad access given to these applications may now present a significant risk to the user's computing device as well as the user.

Process capability techniques are described. In one or more implementations, a capabilities model is utilized to ensure that applications have access to developer-defined resources and cannot access other resources that are not defined by the developer. The capabilities model may therefore prevent exploited applications from taking advantage of resources that are not normally utilized by the application. Additionally, the capabilities for each process may be further examined and decisions may be made based on the presence of these capabilities and/or the lack thereof. For example, if an application with a “webcam” capability requests access to the webcam, the presence of the capability may be used to prompt the user for consent before providing access. A variety of other examples are also contemplated, further discussion of which may be found in relation to the following sections.

In the following discussion, an example environment is first described that may employ the process capability techniques described herein. Example procedures are then described which may be performed in the example environment as well as other environments. Consequently, performance of the example procedures is not limited to the example environment and the example environment is not limited to performance of the example procedures.

Example Environment

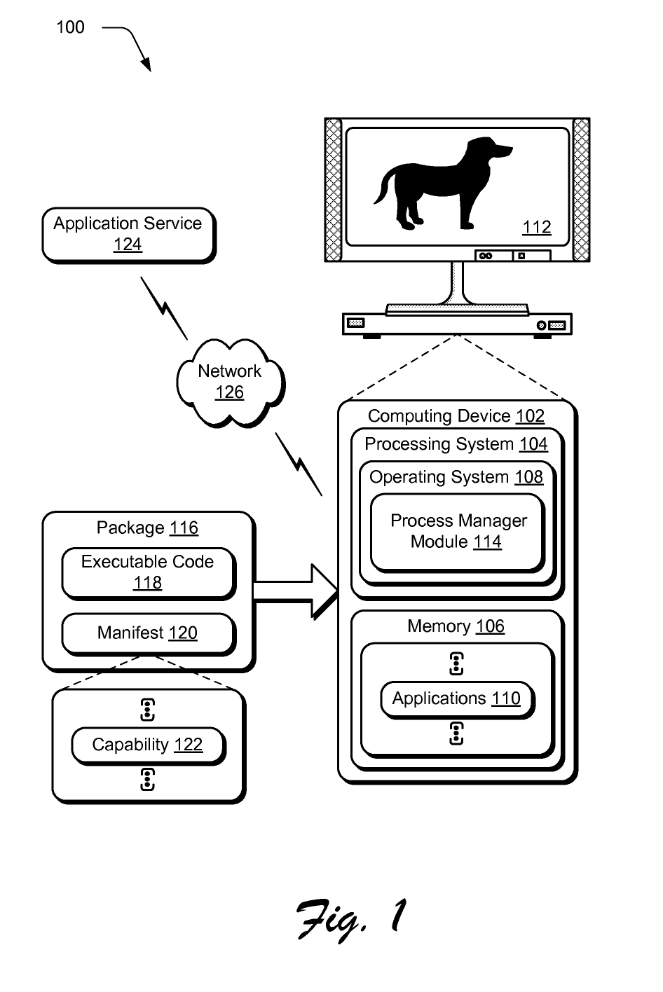

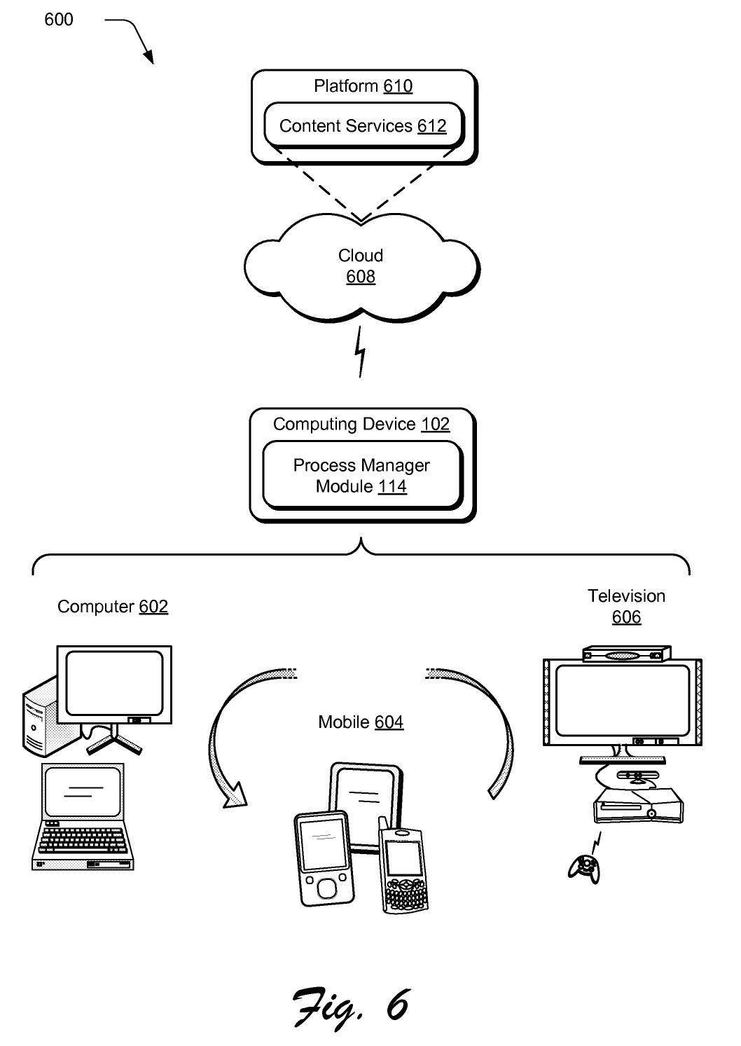

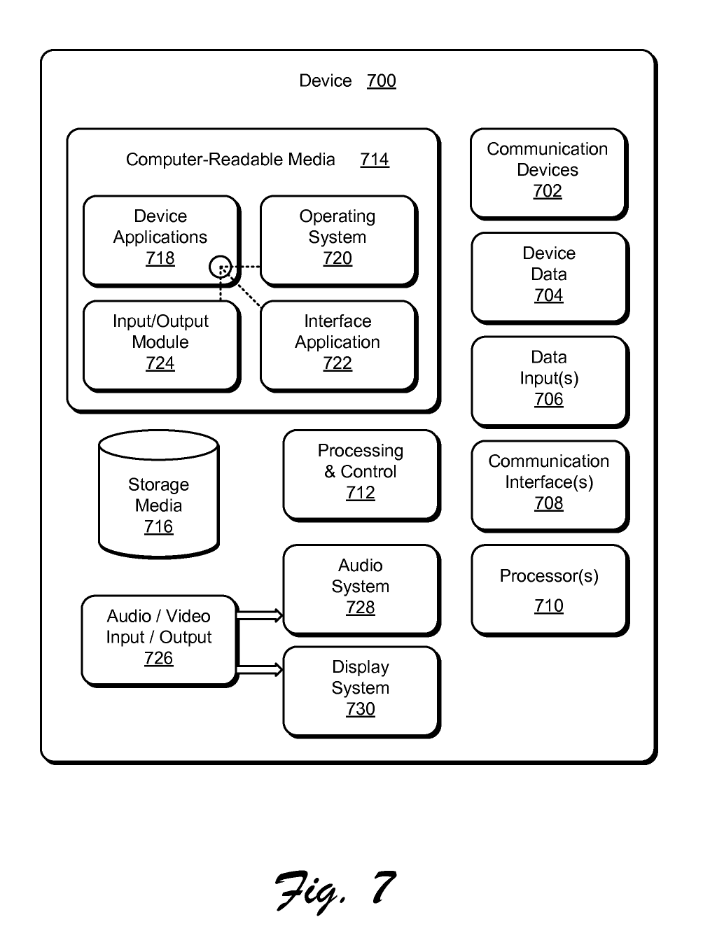

FIG. 1 illustrates an operating environment in accordance with one or more embodiments, generally at 100. Environment 100 includes a computing device 102 having a processing system 104 that may include one or more processors, an example of computer-readable storage media illustrated as memory 106, an operating system 108, and one or more applications 108. Computing device 102 can be embodied as any suitable computing device such as, by way of example and not limitation, a desktop computer, a portable computer, a handheld computer such as a personal digital assistant (PDA), mobile phone, tablet computer, and the like. Different examples of a computing device 102 is shown and described below in FIGS. 6 and 7.

The computing device 102 also includes an operating system 108 that is illustrated as being executed on the processing system 104 and is storable in memory 106. The computing device 102 further includes applications 110 that are illustrated as being stored in the memory 106 and are also executable on the processing system 104. The operating system 108 is representative of functionality of the computing device 102 that may abstract underlying hardware and software resources for use by the applications 110. For example, the operating system 108 may abstract functionality of how data is displayed on the display device 112 without the applications 110 having to “know” how this display is achieved. A variety of other examples are also contemplated, such as to abstract the processing system 104 and memory 106 resources of the computing device 102, network resources, and so on.

The computing device 102 is also illustrated as including a process manager module 114. The process manager module 114 is representative of functionality of the computing device 102 to manage access of executable code to capabilities of the computing device 102. For example, the computing device 102 may receive a package 116 having executable code 118 (e.g., an application) for installation on the computing device 102. The package 116 may also include a manifest 120 generated by a developer of the executable code 118 that describes one or more capabilities 122 of the computing device 102. This description may describe which capabilities of the computing device 102 a process formed through execution of the executable code 118 is permitted and/or not permitted to access. For example, the manifest 120 may list a capability that is to be made accessible to the process and/or may list a capability that is to be made inaccessible to the process. In this way, a developer of the executable code 118 may specify capabilities in the manifest 120 to help reduce and even eliminate an ability of a malicious party to compromise the application to access capabilities that are not typically accessed by the executable code 118.

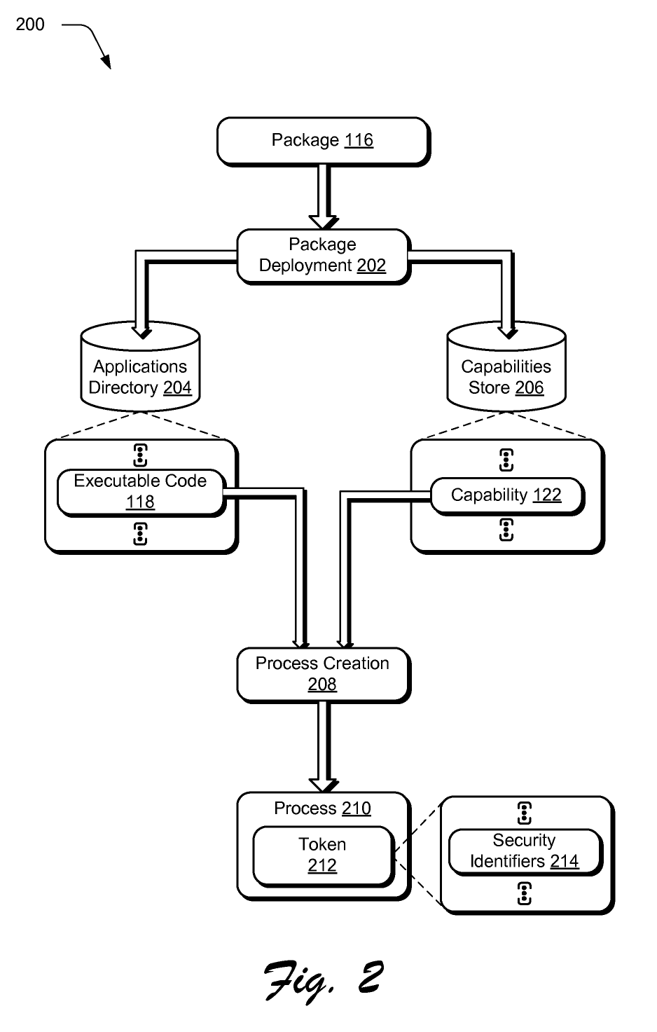

The package 116 may be received for installation on the computing device 102 from a variety of different sources. For example, an application service 124 (e.g., an application store) may be accessed by the computing device 102 via a network 126, e.g., the Internet. Upon purchase, the package 116 that includes the executable code 118 and the manifest 120 may be communicated via the network 126 for installation on the computing device 102. In another example, a user may obtain computer-readable storage media (e.g., an optical disc) that contains the package 116. Further discussion of installation of the package 118 including the executable code 118 and the manifest on the computing device 102 may be found in relation to FIG. 2.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of a system 200 in an example implementation showing installation of a package 116 on the computing device 102 and formation of a token to manage process access to capabilities. As previously described, when a developer creates executable code 118, a manifest 120 may also be created that contains a set of declared capabilities 122 for processes implemented through execution of the code. These capabilities 122 may be registered during installation, which is illustrated as package deployment 202 in FIG. 2.

For example, the executable code 118 may be installed for access via an applications directory 204. The capabilities 122 described in the manifest may be installed in a capabilities store 206 and associated with an identity of the package 116 and/or executable code 118 itself. In one or more implementations, the capabilities store 206 is configured to be tamper resistant such that malicious code cannot gain access to or modify the capabilities 122 described, such as to prevent access to the processes themselves.

During process creation 208 that results from initiation of execution of the executable code 118, an identifier is obtained that is usable by the process manager module 114 to locate capabilities described for the process 210, e.g., an identifier of the package 116, the executable code 118, and so on as described above. These capabilities 122 are then used as part of the process creation 208 to form a token 212 that may be used by the process manager module 114 to control access to the capabilities of the computing device 102.

The token 212, for instance, may include one or more security identifiers 214 that correspond to one or more of the capabilities 122 described in the capabilities store 206 for that process. In other words, the token 212 is populated with the relevant capabilities associated with the package 116, as security identifiers 214. Thus, the process manager module 114 may utilize the token 212 when access to a capability is requested by a process 210 to determine whether that access is to be permitted for that process 210.

In one or more implementations, the token 212 cannot be manipulated by the process 210. The token 212 may also allow the process 210 to participate in access verification checks for a capability (e.g., ACLs for a resource). Further, the process manager module 114 may also implement techniques that involve decisions based on the presence of a capability (or combination of capabilities) before granting access to a capability. Because the process 210 does not have direct access to the token, the process manager module 114 may function as a broker that leverages the immutability of the token 212 to ensure that appropriate access is granted to the process 210.

A variety of different capabilities 122 may be referenced by the security identifiers 214. Additionally, the security identifiers 214 may reference these capabilities in a variety of ways. For example, devices and device interface classes may be encoded directly into the security identifier 214, e.g., the identifier may use 224 bits and a globally unique identifier may utilize 128 bits of the identifier. This may be sued to allow a wide spectrum of devices to be handled by the capability model, including devices that have not yet been released. The device interface class, for instance, may be specified as part of a device definition during installation.

In another example, the security identifiers 214 may reference capabilities 122 to access different types and/or locations of data. A first example of a capability may involve a picture library and include a capability to add, change, or deleted files in the picture library. This may include picture libraries on a local network (e.g., home or work network), locally connected media servers, and so on. Similar techniques may also be utilized to control access to videos, music, and other media files. For documents, access may be controlled for particular document types, document libraries, whether this access is restricted to local libraries or does it include other computing devices available via a local network, and so on.

Additional examples of capabilities may include whether access to removable storage is permitted, such as an external hard drive, USB flash drive, MTP portable device, and so on. This access may include the capability to add/change, or delete specific files from these devices and/or configuration settings of these devices.

Further examples of capabilities include whether access to credentials (e.g., secure credentials storage) is to be permitted. Example credentials include credentials usable to access a corporate intranet, a website, billing credentials, user name and login, and so forth. Yet further examples of capabilities involve certificates. For instance, this may include software and/or hardware certificates (e.g., from a smartcard) usable to identify a particular user, such as to an employer, bank, government entity, certificates used for access control to a physical premises, and so forth. It should be readily apparent that a variety of other examples are also contemplated.

These capabilities may map to an enumeration of security identifiers, where there is one security identifier for each capability. As previously described, devices may also be represented as security identifiers, where the trailing 128 bits of the security identifier are populated with a device interface class GUID.

In one or more implementations, common devices may be assigned a user friendly alias that may be used in a manifest 120 to assist developers The user-friendly alias may then be resolved to a device interface class GUID at installation, e.g., microphone, webcam, location, SMS to text message, proximity to near field proximity, and so on.

Example Procedures

The following discussion describes process access management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

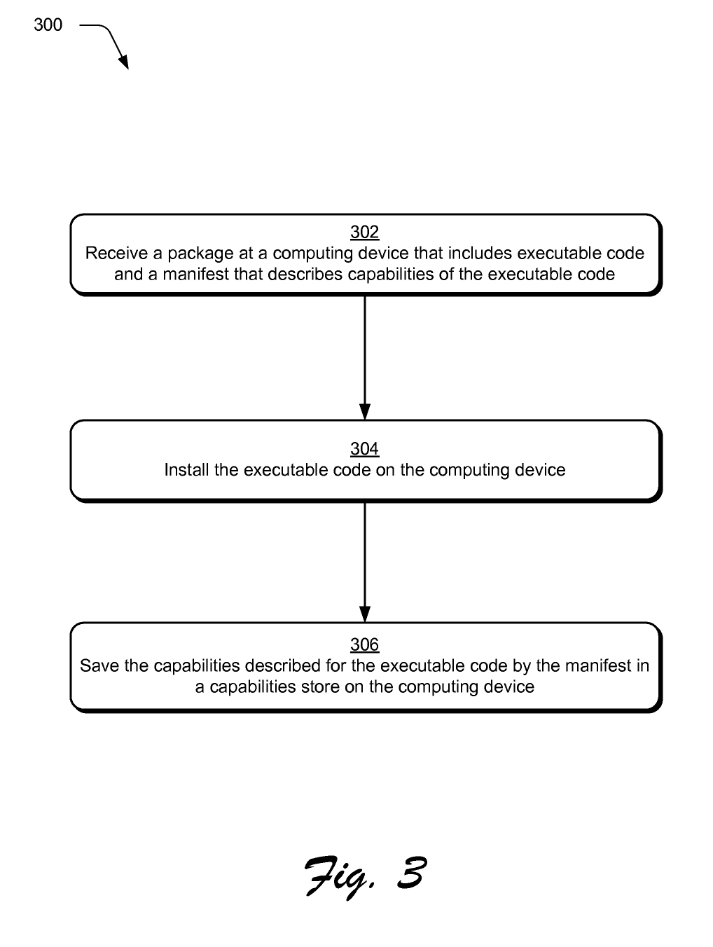

FIG. 3 depicts a procedure 300 in an example implementation in which a package having executable code and a manifest are installed on a computing device. A package is received at a computing device that includes executable code and a manifest that describes capabilities of the executable code (block 302). The package 116, for instance, may be stored on computer readable storage media, downloaded from an application service 124 over a network 126, and so on. As previously described, the manifest 120 may describe capabilities of the computing device 102 that are to be used during execution of the code, as contemplated by a developer of the executable code 122.

The executable code is installed on the computing device for execution (block 304). The executable code, for instance, may be configured as an application to be installed on the computing device for access through an applications directory, a third-party plug-in module, and so forth.

The capabilities described for the executable code by the manifest are saved in a capabilities store on the computing device, the saved capabilities usable to form a token to manage access of one or more processes formed through execution of the executable code to capabilities of the computing device (block 306). The capabilities store 206, for instance, may be configured to be tamper resistant, e.g., physically and/or electronically. In this way, capabilities described therein are not accessible by unauthorized entities, are not accessible by processes that are executed on the computing device 102, and so on. Thus, the description of the capabilities may be considered “trustworthy” and therefore used to form a token that may be used to manage access by the process, further discussion of which may be found in relation to the following figure.

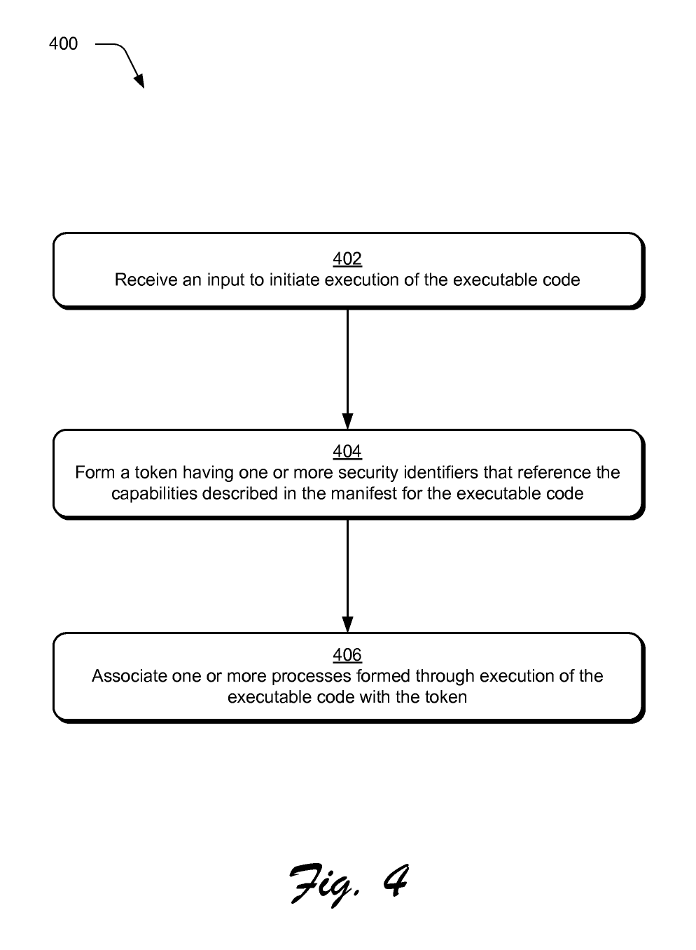

FIG. 4 depicts a procedure 400 in an example implementation in which a token is formed responsive to initiating execution of the executable code installed in FIG. 4. An input is received to initiate execution of executable code installed on the computing device (block 402). The input, for instance, may be received through user selection of a representation of the code, e.g., an icon, tile, and so on. The input may also originate from the code itself (e.g., wake at predetermined intervals), from other code executed on the computing device 102, and so on.

A token is formed having one or more security identifiers that reference capabilities described in a manifest for the executable code (block 404). As previously described, the security identifiers 122 may enumerate capabilities that are described in the capabilities store 206.

One or more processes formed through execution of the executable code on the computing device are associated with the token, the token usable to manage access of the one or more processes to the capabilities of the computing device (block 406). The token 212, for instance, may include an identifier that matches an identifier of the executable code 118 and/or package 116, may be passed by the executable code 118 itself when requesting access to a capabilities (e.g., the token itself and/or an identifier usable to find the token 212), and so forth. The token 212 may then be used to manage access of the process 210 to one or more capabilities of the computing device 102, an example of which may be found in relation to the following figure.

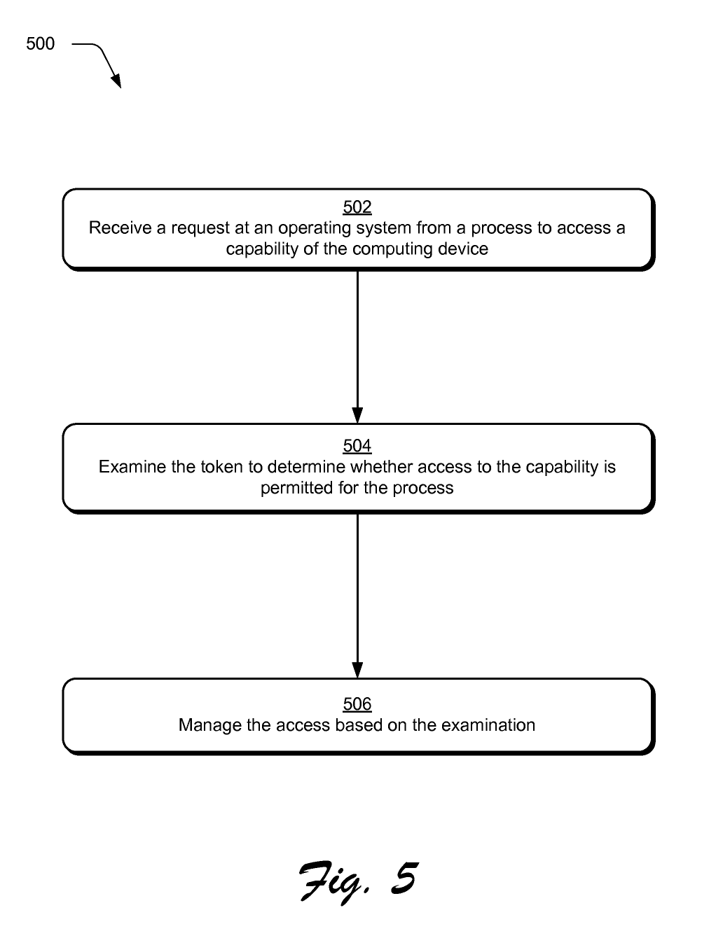

FIG. 5 depicts a procedure 500 in an example implementation in which access to capabilities are managed by a computing device using the token formed in FIG. 4. A request is received from a process to access a capability of the computing device (block 502). The process 210, for instance, may be implemented through execution of the executable code 118 by the computing device 102.

A token is examined that corresponds to the process to determine whether access to the capability is permitted for the process, the token having one or more security identifiers that reference capabilities described in a manifest that corresponds to the process (block 504). As described, the token 212 may be located by the process manager module 114 in a variety of ways. The token 212 may also be formed to describe access that is permitted (e.g., reference the capabilities that are permitted) and/or describe access that is not permitted, e.g., reference capabilities that are not permitted to be access by a corresponding process 210.

Access to the capability is managed based on the examination of the token (block 506). The process manager module 114, for instance, may receive a request from the process 210 to access a capability, such as a web camera. The process manager module 114 may then examine the token 212 to determine whether this access is permitted, such as to locate a security identifier that references the web camera, a device interface class, and so on. Thus, the process manager module 114 may readily determine what access is permitted and reach accordingly. As previously described, a variety of other examples are also contemplated, such as to determine which access is not permitted based on enumeration by the token 212.

Example System and Device

FIG. 6 illustrates an example system 600 that includes the computing device 102 as described with reference to FIG. 1. The example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 602, mobile 604, and television 606 uses. Each of these configurations includes devices that may have generally different constructs and capabilities, and thus the computing device 102 may be configured according to one or more of the different device classes. For instance, the computing device 102 may be implemented as the computer 602 class of a device that includes a personal computer, desktop computer, a multi-screen computer, laptop computer, netbook, and so on.

The computing device 102 may also be implemented as the mobile 604 class of device that includes mobile devices, such as a mobile phone, portable music player, portable gaming device, a tablet computer, a multi-screen computer, and so on. The computing device 102 may also be implemented as the television 606 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 608 includes and/or is representative of a platform 610 for content services 612. The platform 610 abstracts underlying functionality of hardware (e.g., servers) and software resources of the cloud 608. The content services 612 may include applications and/or data that can be utilized while computer processing is executed on servers that are remote from the computing device 102. Content services 612 can be provided as a service over the Internet and/or through a subscriber network, such as a cellular or Wi-Fi network.

The platform 610 may abstract resources and functions to connect the computing device 102 with other computing devices. The platform 610 may also serve to abstract scaling of resources to provide a corresponding level of scale to encountered demand for the content services 612 that are implemented via the platform 610. Accordingly, in an interconnected device embodiment, implementation of functionality of the functionality described herein may be distributed throughout the system 600. For example, the functionality may be implemented in part on the computing device 102 as well as via the platform 610 that abstracts the functionality of the cloud 608.

FIG. 7 illustrates various components of an example device 700 that can be implemented as any type of computing device as described with reference to FIGS. 1, 2, and 6 to implement embodiments of the techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and an input/output module 724 that are shown as software modules and/or computer applications. The input/output module 724 is representative of software that is used to provide an interface with a device configured to capture inputs, such as a touchscreen, track pad, camera, microphone, and so on. Alternatively or in addition, the interface application 722 and the input/output module 724 can be implemented as hardware, software, firmware, or any combination thereof. Additionally, the input/output module 724 may be configured to support multiple input devices, such as separate devices to capture visual and audio inputs, respectively.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
responsive to an input received to initiate execution of executable code installed on the computing device, forming a token having one or more security identifiers that reference capabilities described in a manifest for the executable code; and
associating one or more processes formed through execution of the executable code on the computing device with the token, the token usable to manage access of the one or more processes to the capabilities of the computing device.

2. A method as described in claim 1, wherein the security identifiers reference which capabilities of the computing device are to be made accessible to the one or more processes.

3. A method as described in claim 1, wherein the forming of the token includes accessing a description of the capabilities stored in a tamper-resistant location of the computing device that is not accessible to the one or more processes.

4. A method as described in claim 3, wherein the description of the capabilities is stored in the tamper-resistant location as part of installation of the executable code on the computing device.

5. A method as described in claim 1, wherein the manifest and the executable code are installed on the computing device from a package, the package and manifest formed by a developer of the executable code.

6. A method as described in claim 1, wherein the forming and the associating are performed through execution of an operating system on the computing device.

7. A method as described in claim 1, wherein the token is usable to manage access of the one or more processes to the capabilities of the computing device by causing output of a prompt that is readable by a user to indicate whether the access is permitted.

8. A method as described in claim 1, wherein the at least one of the security identifiers also describes a device or a device interface class.

9. A method as described in claim 1, wherein at least one said capability described in the manifest indicates whether access to pictures, videos, or music stored on the computing device is permitted for the one or more processes.

10. A method as described in claim 1, wherein at least one said capability described in the manifest indicates whether access to a documents library available locally on the computing device is permitted for the one or more processes.

11. A method as described in claim 1, wherein at least one said capability described in the manifest indicates whether access to files available locally on the computing device via removable storage is permitted for the one or more processes.

12. A method as described in claim 1, wherein at least one said capability described in the manifest indicates whether access to credentials usable to obtain access to an intranet is permitted for the one or more processes.

13. A method as described in claim 1, wherein at least one said capability described in the manifest indicates whether access to certificates stored locally on the computing device is permitted for the one or more processes.

14. A method comprising:
receiving a package at a computing device that includes executable code and a manifest that describes capabilities of the executable code;
installing the executable code on the computing device for execution; and
saving the capabilities described for the executable code by the manifest in a capabilities store on the computing device, the saved capabilities usable to form a token to manage access of one or more processes formed through execution of the executable code to capabilities of the computing device.

15. A method as described in claim 14, wherein the capabilities store is configured such that it is not accessible to one or more processes formed through execution of the executable code.

16. A method as described in claim 14, wherein the capabilities describe whether access to particular devices or files is permitted.

17. A method as described in claim 14, further comprising:
launching one or more processes through execution of the executable code on the computing device;
forming the token, by the computing device, having one or more security identifiers that reference the saved capabilities for the executable code; and
using the token, by the computing device, to manage access of the one or more processes to the capabilities of the computing device.

18. A method as described in claim 14, wherein the receiving, installing, saving, launching, forming, and using are performed through execution of an operating system on the computing device.

19. One or more computer-readable storage media comprising instructions stored thereon that, responsive to execution on a computing device, causes the computing device to execute an operating system to perform operations comprising:
receiving a request from a process to access a capability of the computing device;
examining a token that corresponds to the process to determine whether access to the capability is permitted for the process, the token having one or more security identifiers that reference capabilities described in a manifest that corresponds to the process; and
managing the access to the capability based on the examination of the token.

20. One or more computer-readable storage media as described in claim 18, wherein at least one of the security identifiers describe:
a device;
a device interface class;
whether access to pictures, videos, or music stored on the computing device is permitted;
whether access to a documents library available locally on the computing device is permitted;
whether access to files available locally on the computing device via removable storage is permitted;
whether access to credentials usable to obtain access to an intranet is permitted; and
whether access to certificates stored locally on the computing device is permitted.
